(19) United States
(12) Patent Application Publication
(10) Pub. No.: US 2010/0166018 A1
(43) Pub. Date: Jul. 1, 2010

(54) Method for generating multimedia files intended to be transmitted by packets in a peer-to-peer network

(76) Inventors: Francois Gerard, Beignon (FR); Yvon Legallais, Rennes (FR); Anthony Laurent, Vignoc (FR)

Correspondence Address: Robert D. Shedd, Patent Operations;THOMSON Licensing LLC, P.O. Box 5312, Princeton, NJ, 08543-5312, US

(21) Appl. No.: 12/655,143

(22) Filed: Dec. 23, 2009

(30) Foreign Application Priority Data
Dec. 29, 2008 (EP) 0859104

(51) Int. Cl. H04J 3/24

(52) U.S. Cl. 370/474

(57) ABSTRACT

The present invention relates to a method for generating multimedia files intended to be transmitted via a peer-to-peer network by packets of the same size, each of these multimedia files being obtained from an intermediary file comprising:
a content common to the intermediary files, formed by primary data, and
a content specific to each intermediary file, formed by secondary data introduced into an insertion zone delimited by primary data of the common content,
   wherein these files are generated by introducing filling data in the insertion zones of intermediary files such that a limit of these insertion zones corresponds to a limit between two distinct transmission packets.

The present invention relates to a method for generating multimedia files intended to be transmitted by packets in a peer-to-peer network

It is known in the art to use the Internet network to access to multimedia contents, particularly to view video contents that can be accessed in VoD (Video On Demand).

According to a broadcast mode, these video contents can be transmitted by downloading, in which case it is necessary to recover the file set coding this video content prior to its restitution.

The implementation of a broadcast via a peer-to-peer network can then facilitate this recovery.

In fact, a peer-to-peer network is formed by a plurality of servers that can transmit and receive files such that each server of the network, having received a file, can retransmit it to the other network servers. Thereafter, such a server is referred to as a peer.

In order to provide the files to broadcast to the peer-to-peer network, an operator can prepare the latter using a server referred to as the “seed server” or “Content Preparation Server”.

Such an operator server defines a first zone of the peer-to-peer network with regard to a second zone formed by the peers that, as indicated, can fulfil the functions of clients and of servers.

In order to respond to a content purchase request, the operator server transmits a purchase ticket transmitted with two lists described below:
A list of packets, also referred to as chunks, forming the multimedia file and used to distribute the file coding this content in the peer-to-peer network. This list is referred to as the content map.
A list of servers, comprising at least one operator server and the peers, through which this file can be totally—all of its packets—or partially—some packets—recovered. This list is referred to as the peer list.

It appears that the operation of a peer-to-peer network is particularly effective, notably in terms of rapidity and response reliability, when a same file is distributed repeatedly.

Indeed, in this case, the packets that have already been distributed once, via the peers, can be used via the same peers to respond to any new request.

However, video content providers may want to customize the contents delivered in these networks according to determined profiles in order to customize and/or adapt their content offer. For example, different publicity messages can alternatively be inserted in a film transmitted by a peer-to-peer network according to the geographical location of the peer requiring the downloading of this film.

For example, other criteria can be cited to customize/adapt a content offer such as, without being exhaustive, a subscription category, an applicant socio-professional category, a history of requests and/or purchases previously made, preferences declared by the applicant in a questionnaire.

In this case, the specificity of each multimedia file thus generated leads to a plurality of distinct multimedia contents and, consequently, multiplies the quantity of files, and derived packets, needing to be processed by a peer-to-peer network.

The present invention aims to overcome this disadvantage. It results from the recognition that the transmission, in a peer-to-peer network, of two files having a difference, even relatively minor, in contents may require totally distinct packets for each of these files.

In fact, the packets implemented in a peer-to-peer network generally have a constant size such that, for example, a data insertion in a file offsets the set of data of this file downstream of the insertion with respect to the reading direction of this file.

For this reason, the present invention relates to a method for generating multimedia files intended to be transmitted via a peer-to-peer network by packets of the same size, each of these multimedia files being obtained from an intermediary file comprising:
a content common to the intermediary files, formed by primary data, and
a content specific to each intermediary file, formed by secondary data introduced in an insertion zone delimited by primary data,
   characterized in that these multimedia files are generated by introducing filling data in the insertion zones of intermediary files such that a limit of these insertion zones corresponds to a limit between two distinct transmission packets.

By means of a method in accordance with the invention, it is possible to increase the quantity of packets common to more than one multimedia files transmitted via a peer-to-peer network.

In fact, the filling data are used to compensate the offset, due to the insertion of data as previously described, between the packets transporting multimedia data that differ as a result of an insertion of distinct data.

Thus, the transmission of data present in the insertion zones (secondary data or filling data) can be carried out by means of dedicated packets such that the transmission of common content, situated outside of this limit, can be carried out from the same common packets.

In an embodiment, filling data are introduced between the secondary data and the insertion zones limit corresponding to a limit between two distinct packets.

According to an embodiment, the filling data are introduced according to parameters common to the intermediary files.

For example, the parameters common to the intermediary files can comprise at least one of the following parameters: the location of insertion zones in a common file, a predetermined size of packets to be transmitted, the sizes of intermediary files, a location rule for filling data in a packet.

Thus, such a location rule for filling data in a packet may require the location of these filling data at the start or the end of a packet.

In this case, the information indicating the quantity of filling data, situated at the start or end of a packet, can be associated with this packet in the packets list or content map.

In an embodiment, a contents list is associated with a first generated multimedia file identifying at least a second multimedia file having common packets with this first multimedia file.

The invention also relates to an operator server generating multimedia files intended to be transmitted by packets in a peer-to-peer network, each of these multimedia files being obtained from an intermediary file comprising:
a common content formed by primary data,
a specific content formed by secondary data introduced in an insertion zone situated between the primary data of common content,
   characterized in that comprises means for generating these files by introducing filling data in the insertion zones of intermediary files such that a limit of these insertion zones corresponds to a limit between two distinct transmission packets in accordance with one of the preceding embodiments.

In an embodiment, the operator server comprises:
means for receiving a request for transmission of common content, and
means for transmitting a list of packets and a list of servers of a generated multimedia file, this multimedia file being selected according to parameters specific to the request from this client server.

The invention also relates to a peer intended to receive and transmit multimedia files in a peer-to-peer network, each of these multimedia files being obtained from an intermediary file comprising:
a common content formed by primary data,
a specific content formed by secondary data introduced in an insertion zone situated between the primary data of common content,
   characterized in that it comprises means for detecting filling data inserted between the data of a multimedia file according to a method in accordance with one of the preceding embodiments, and
means for deleting these filling data in order to reproduce the multimedia content of the file without considering the filling data.

According to an embodiment, the peer comprises means for reinserting the deleted filling data before transmitting the multimedia file to another peer.

The invention also relates to multimedia files intended to be transmitted by packets in a peer-to-peer network, each of these multimedia files being obtained from an intermediary file comprising:
a common content formed by primary data,
a specific content formed by secondary data introduced in an insertion zone situated between the primary data of common content,
   characterized in that they comprise filling data in their insertion zones such that a limit of these insertion zones corresponds to a limit between two distinct transmission packets in accordance with one of the preceding embodiments.

### BRIEF DESCRIPTION OF THE FIGURES

Other characteristics and advantages of the invention will clearly emerge from the description provided below as a non-restrictive example, with reference to the different annexed figures that show:

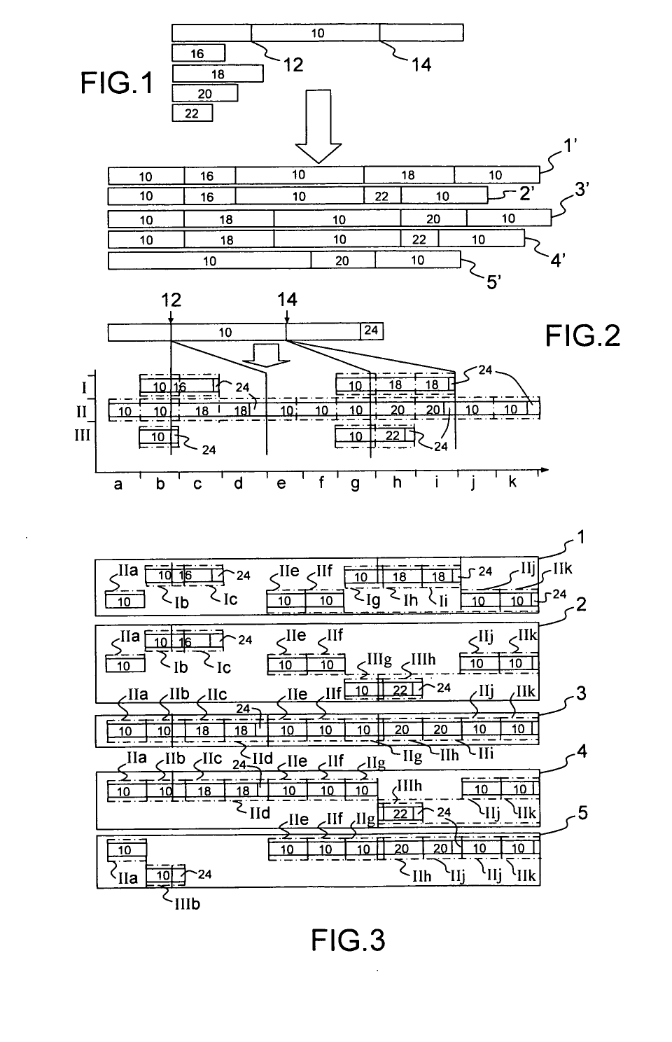

in FIG. 1, intermediary files formed by a common content and contents specifically inserted previous to the implementation of the invention,

in FIG. 2, packets, common or specific to different multimedia files, generated from intermediary files of FIG. 1 in accordance with the invention, and

in FIG. 3, multimedia files formed by the packets of FIG. 1 in accordance with the invention.

### DESCRIPTION OF PREFERRED EMBODIMENTS OF THE INVENTION

The elements having a same function, appearing on different figures, conserve unless otherwise specified, the same references.

In reference to FIG. 1 is represented a common content 10, formed by primary data, intended to form 5 multimedia files, by different introductions of specific content 16, 18, 20 and/or 22 in insertion zones 12 and 14 of this common content.

More specifically, these 5 multimedia files must be generated as indicated below:
The first file: 10+16 (zone 1)+18 (zone 2)
The second file: 10+16 (zone 1)+22 (zone 2)
The third file: 10+18 (zone 1)+20 (zone 2)
The fourth file: 10+18 (zone 1)+22 (zone 2)
The fifth file: 10+20 (zone 2)

In this example, these insertion zones 12 and 14 are selected by an operator in order to be acceptable and/or pertinent with respect to the video content of the common file 10. Thus, the operator can avoid interrupting a dialogue or an action scene with an advertisement.

When the specific contents 16, 18, 20 and/or 22 are inserted in the common file 10, the represented intermediary files 1′, 2′, 3′, 4′ or 5′ are generated.

These intermediary files 1′, 2′, 3′, 4′ or 5′ have variable lengths such that their decomposition into packets of the same size generates numerous packets specific to each of the files, thus limiting the interest of a transmission via a peer-to-peer network as previously noted.

For this reason, a software tool is implemented to introduce filling data into the insertion zones 12 or 14 such that a limit of each of these insertion zones 12 and 14 corresponds to a limit between two distinct transmission packets.

Such an implementation generates more than one common and/or specific packets as identified in FIG. 2 by an ordinate—I, II or III—and an abscissa—a, b, c, . . . j or k,—the various sought multimedia files being able to be formed from these common and/or specific packets as shown in FIG. 3.

In this example, the considered limit of insertion zones 12 and 14 is the limit situated downstream with respect to the file reading direction—or reproduction direction, this direction being represented by an arrow in FIG. 2.

Thus, the primary data situated downstream of an insertion zone can be transmitted by common packets—IIe and IIf for zone 12, IIj, IIk for zone 14—while all of the secondary or filling data—situated in an insertion zone can be transmitted by specific packets—Ic, IIc, IId for zone 12, Ih, Ii, IIh, Iii, IIIh for zone 14.

In addition, the primary data situated at the upstream limit of an insertion zone can also be transmitted in a common packet considering, for example, that the packet transmitting these primary data is completed by filling data.

However, in this embodiment, these primary data situated upstream of an insertion zone form a specific packet—Ib, IIb or IIIb for zone 12, Ig, IIg or IIIg for zone 14—for each multimedia file forming a packet with secondary data of a specific content, which enables limiting the quantity of filling data used by the method.

Indeed, the software tool can take into consideration numerous approaches and numerous parameters to insert filling data such as, without limitation, the location of insertion zones 12 or 14, the imposed size of packets and the sizes of intermediary files 1′, 2′, 3′, 4′ or 5′.

It should be noted that, when the multimedia files have identical specific contents, the software tool can also produce packets of secondary data common to these files, such as the packets Ib and Ic (files 1 and 2).

As shown in FIG. 3, the 5 multimedia files 1, 2, 3, 4 and 5 generated have numerous common packets, both for the set of these multimedia files such as the packets IIa, IIe, IIf and IIk, as for a limited number of these files such as the packets Ib and Ic common to the files 1 and 2.

More specifically, noting CMi as the Content Map of file i, this latter is then composed of:

File 1: CM1={IIa, Ib, Ic, IIe, IIf, Ig, Ih, Ii, IIj, IIk}

File 2: CM2={IIa, Ib, Ic, IIe, IIf, IIIg, IIIh, IIj, IIk}

File 3: CM3={IIa, IIb, IIc, IId, IIe, IIf, IIg, IIh, Iii, IIj, IIk}

File 4: CM4={IIa, IIb, IIc, IId, IIe, IIf, IIg, IIIh, IIj, IIk}

File 5: CM5={IIa, IIIb, IIe, IIf, IIg, IIh, Iii, IIj, IIk}

In accordance with the operation of peer-to-peer networks previously described, to each multimedia file is associated a list of packets or a “content map” that enables this file to be generated.

However, the invention enabling the implementation of common packets, a first multimedia file generated according to the invention should also be associated with a list of packets identifying at least a second multimedia file having common packets with this first multimedia file.

Thus, a peer wanting to obtain common packets could require these latter from peers storing another multimedia file that nevertheless has these common packets.

The present invention is susceptible to numerous variants. Notably of numerous parameters/approaches that can be taken into account to introduce the filling data into the insertion zones, such as for example the parameters linked to the hardware or software constraints specific to the peer-to-peer network.

For example, the example described above used an implicit filling data location rule such that, in a packet, these filling data are situated at the end of the packet. However it should be noted that the filling data can be freely located in the insertion zone.

Moreover, in the example described above, the specific data can be attached to the primary data in a same packet. This corresponds for example to the packet lb of FIG. 2, that contains the primary data 10 and a part of the specific data 16. The separation of these data can be rendered voluntarily complicated, so that these data must be read together. Thus if the specific data 16 corresponds to advertising, the primary data 10 can only be read with this advertising. Alternatively, these data can be linked in such a way that they can be read independently of one another.

In any case, in the metadata associated with a packet, the quantity of filling data and their location, for example at the start or the end of a packet, should be indicated.

1-12. (canceled)

13. Method for generating multimedia files intended to be transmitted via a peer-to-peer network by packets of the same size, each of these multimedia files being obtained from an intermediary file comprising:
a content common to all the intermediary files formed by primary data, and
a content specific to each intermediary file, formed by secondary data introduced into an insertion zone delimited by primary data of said common content,
wherein these files are generated by introducing filling data into the insertion zones of said intermediary files such that a limit of these insertion zones corresponds to a limit between two distinct transmission packets.

14. Method according to claim 1 wherein the filling data are introduced between the secondary data of a specific content and the limit of insertion zones corresponding to a limit between two distinct packets.

15. Method according to claim 1 wherein the filling data are introduced according to parameters common to the intermediary files.

16. Method according to claim 3 wherein the parameters common to the intermediary files comprise at least one of the following parameters: the location of insertion zones in a common file, a predetermined size of packets to be transmitted, the sizes of intermediary files, a location rule for filling data in a packet.

17. Method according to claim 4 wherein the rule for location of filling data in a packet requires the location of these filling data at the start or end of the packet.

18. Method according to claim 5 wherein the information indicating the quantity of filling data, situated at the start or end of a packet, are associated with this packet.

19. Method according to claim 1 wherein a first generated multimedia file is associated with a list of contents identifying at least a second multimedia file having packets common with this first multimedia file.

20. Operator server generating multimedia files intended to be transmitted by packets in a peer-to-peer network, each of these multimedia files being obtained from an intermediary file comprising:
a common content formed by primary data,
a specific content formed by secondary data introduced in an insertion zone situated between the primary data of said common content,
comprising means for generating these files by introducing filling data in the insertion zones of said intermediary files such that a limit of these insertion zones corresponds to a limit between two distinct transmission packets according to a method in accordance with claim 1.

21. Operator server according to claim 8, comprising:
means for receiving a request for transmission of common content, and
means for transmitting a list of packets and a list of servers of a generated multimedia file, this multimedia file being selected according to parameters specific to the request from this client server.

22. Peer intended to receive and transmit multimedia files via a peer-to-peer network, each of these multimedia files being obtained from an intermediary file comprising:
a common content formed by primary data,
a specific content formed by secondary data introduced into an insertion zone situated between the primary data of common content,
comprising means for detecting filling data inserted between the data of a multimedia file according to a method in accordance with claim 1, and
means for deleting these filling data in order to reproduce the multimedia content of the file without considering the filling data.

23. Peer according to claim 10 comprising means for reinserting filling data deleted before transmitting the multimedia file to another peer.

24. Multimedia files intended to be transmitted by packets in a peer-to-peer network, each of these multimedia files being obtained from an intermediary file comprising:
a common content formed by primary data,
a specific content formed by secondary data introduced into an insertion zone situated between the primary data of common content,
wherein they comprise filling data in their insertion zones such that a limit of these insertion zones corresponds to a limit between two distinct transmission packets in accordance with claim 1.
